(19) United States
(12) Patent Application Publication
(10) Pub. No.: US 2004/0154718 A1
(43) Pub. Date: Aug. 12, 2004

(54) Polyurethane filled tire and method of making same

(76) Inventor: Van I. Doesburg, Dalton, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/360,543

(22) Filed: Feb. 6, 2003

(51) Int. Cl. B60C 7/10; B29D 30/02; B60C 17/06; B29D 30/04

(52) U.S. Cl. 152/310; 156/112; 152/157; 156/113

(57) ABSTRACT

There is disclosed a polyurethane filled vehicle tire. The tire at least partially defines a hollow cavity, which is at least partially filled with cured frothed polyurethane foam. A method of producing a polyurethane filled tire is also disclosed.

### FIELD OF INVENTION

The present invention relates generally to tires, and, more specifically, to tires at least partially filled with polyurethane compositions; especially frothed polyurethane compositions. A method of making polyurethane-filled tires is also disclosed.

### BACKGROUND OF THE INVENTION

The principal drawback of air-filled vehicle tires, such as tires used on automobiles, trucks, tractors, and the like, is that when the tire is punctured by a sharp object, it promptly loses air and goes flat. This necessitates having to change the tire on the vehicle. Therefore, the art has long sought a vehicle tire with a solid filler in lieu of air to avoid the tires going flat when punctured.

Polyurethane compositions are well known in the art. Polyurethane compositions can be solid or cellular, flexible or rigid. Solid polyurethane compositions are used for many applications, such as insulative structural members and textile coatings, such as carpet backing coatings to adhere tufts of yam to primary backing materials or to adhere secondary backing materials to primary backing materials. Cellular polyurethane, such as foamed or frothed polyurethane, is used for items such as cushions and textile coatings, such as integrally attached cushions for carpet.

The use of elastomeric fillings, including polyurethane fillings, for tires wherein the filling is used in place of air under pressure is known. Such tires are usually placed on heavy duty vehicles used in rugged terrains, including mining vehicles, construction equipment, forklifts, golf carts, wheelbarrows and other similar wheeled vehicles. Heretofore, the polyurethane used in vehicle wheels was either a solid elastomer or a chemically blown polyurethane foam which is blown in situ; i.e., chemical blowing takes place after the liquid polyurethane composition is introduced into the tire cavity. The use of such polyurethane compositions in tires is shown in the following U.S. Pat. Nos. 6,187,125; 5,402,839; 5,070,138; 4,230,168; 4,094,353; and 3,605,848 (the disclosures of which are incorporated herein by reference). The tires associated with the prior art are not completely satisfactory for several reasons, including insufficient wear resistance. Therefore, there is a need for an improved polyurethane filled tire having improved properties.

### SUMMARY OF THE INVENTION

The present invention satisfies the above-described needs by providing an improved polyurethane filled tire. The improved polyurethane filled tire at least partially defines a hollow cavity. The hollow cavity is at least partially filled with cured frothed polyurethane foam. Also, the frothed polyurethane foam has a density after curing of approximately 7 lbs to 30 lbs per cubic foot.

In an alternate embodiment, the present invention comprises a method of making a polyurethane filled tire. The method comprises the steps of forming a mixture of at least one polyol, an isocyanate, a catalyst or catalyst system for forming polyurethane, and a surfactant into a frothed foam. The frothed polyurethane foam is then injected into the cavity at least partially defined by the tire casing thereby displacing air under pressure in a tire casing with the frothed foam. The frothed polyurethane foam in the tire cavity is then cured in place.

Accordingly, it is an object of the present invention to provide an improved polyurethane filled tire and a method of making an improved polyurethane filled tire.

Another object of the present invention is to provide an improved tire for off-road use.

A further object of the present invention is to provide a polyurethane filled tire having improved physical properties.

Yet another object of the present invention is to provide a polyurethane filled tire hiving improved wear resistance.

These and other objects, features and advantages of the present invention will become apparent after a review of the following detailed description of the disclosed embodiments and the appended drawing and claims.

### BRIEF DESCRIPTION OF THE DRAWING

FIG. 1 is a perspective view of a disclosed embodiment of a tire in accordance with the present invention.

FIG. 2 is a cross-sectional view of the tire shown in FIG. 1 taken along the line 2-2.

FIG. 3 is a graph of load versus deflection for three commercially available flat proof tires, a conventional pneumatic tire and a tire in accordance with the present invention.

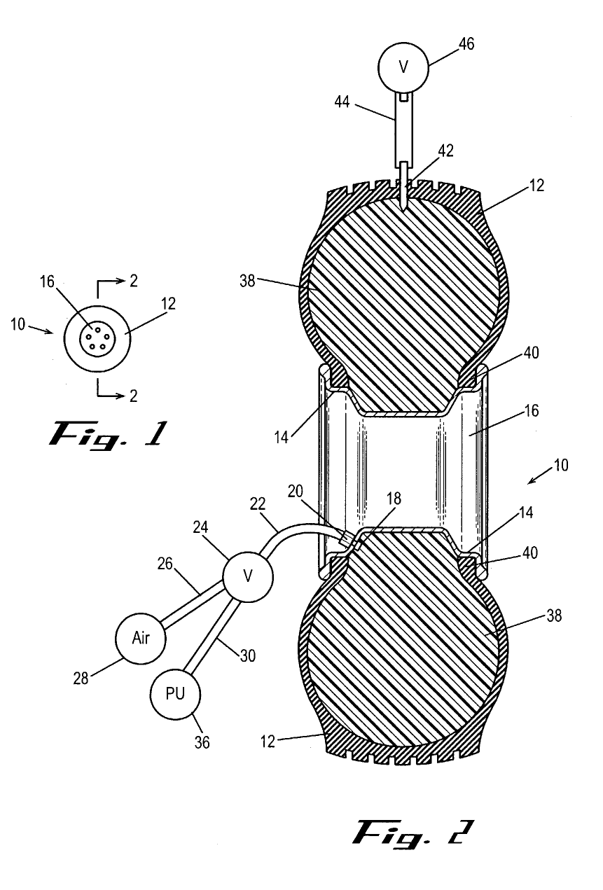

### DETAILED DESCRIPTION OF THE DISCLOSED EMBODIMENTS

The present invention relates to polyurethane filled tire and to method of making polyurethane filled tires. With reference to the drawing in which like numbers indicate like elements throughout the several views, it will be seen that there is a tire 10 in accordance with the present invention. The tire 10 comprises a tire carcass 12 mounted on a rim 14 of a wheel 16 for a vehicle (not shown) in a manner well known to those skilled in the art. The rim 14 has an opening 18 in which is mounted a valve stem 20 through which fluids may pass into the tire 10. The valve stem 20 includes a check valve (not shown) so that fluids may flow into the tire through the valve stem, but may not pass through the valve stem in the opposite direction. Removably connected to the valve stem 20 is a tube 22. The tube 22 is connected to a two-way valve 24. The valve 24 is connected to a tube 26 which is connected to a source of air under pressure 28, such as a pressure tank or a pump. The valve 24 is also connected to a tube 30 which is connected to a source of uncured, frothed polyurethane composition 36; i.e., an uncured, frothed polyurethane dispenser.

Polyurethane compositions are well known to those skilled in the art. Polyurethane is a polymerization product of a polyol component, an isocyanate component, water (optional) and a catalyst system that promotes a polymerization reaction between the isocyanate component and the polyol component to form the polyurethane. Conventional practice in the art is to form an isocyanate mixture, referred to as SIDE A; and to form a mixture of polyols, chain extenders, cross-linking agents, fillers, blowing agents, surfactants, catalysts, etc., commonly referred to as SIDE B. The SIDE A component and the SIDE B component are mixed together at a desired ratio to form the polyurethane polymer. See U.S. Pat. No. 5,159,012 the disclosure of which is incorporated herein by reference.

The polyol component may contain either a single polyol or a mixture of two or more polyols. The specific polyols useful in the manufacture of polyurethane elastomers are well known in the art and include aliphatic, alicyclic and aromatic polyols. More specifically, the polyol component useful in this invention has an average functionality within the range of 2-8, preferably within the range of 2-3, and an average molecular weight of from about 900 to about 9000, preferably from about 1000 to about 6000. The polyol component may contain isomeric and polymeric polyols. Additionally, the polyol component has a hydroxyl number of less than about 150, preferably less than about 137.

The preferred polyols suitable for use in the present invention include, but are not limited to, ethylene glycol; diethylene glycol; propylene glycol; dipropylene glycol; glycerin; sucrose; butylene glycol; polyether polyols derived from ethylene oxide, propylene oxide, and mixtures of such oxides; polyether polyols derived from propylene oxide and capped with ethylene oxide; polyethylene glycol; polypropylene glycol; polybutylene glycol; 1,2-polydimethylene glycol; polydecamethylene glycol and mixtures of the above polyols.

The isocyanate component may contain either a single isocyanate or a mixture of two or more isocyanates. The specific isocyanates useful in the manufacture of polyurethane polymers are well known in the art and include, but are not limited to, aliphatic, alicyclic and aromatic isocyanates. Preferred isocyanates have an average functionality within the range of 2-8, preferably within the range of 2-5. Examples of preferred isocyanates are 2,4-toluene diisocyanate; 2,6-toluene diisocyanate; 1,6-hexamethylene diisocyanate; naphthalene-1,4-diisocyanate; diphenyl methane 4,4′-diisocyanate; 4,4′-diphenylene diisocyanate; 3,3′-dimethoxy biphenylene diisocyanate; polymeric forms of the above diisocyanates, diisocyanato carbodiimide modified diphenylmethane 4,4′-diisocyanate (MDI), isocyanate terminated prepolymers, and mixtures of the foregoing. The isocyanate component (Side A) usually is employed in stoichiometric excess to assure complete reaction with the functional groups of the polyol and with any water that may be present. Preferably, from 20 to 80 parts isocyanate per one hundred parts of polyol are used in the reaction mixture.

Polyurethane compositions can be either foamed or unfoamed. In those instances where foaming is desired, such can be accomplished by using an inert gas frothing technique, a volatile liquid blowing agent technique, a chemically blown (water) technique or combinations thereof, in conjunction with a surface active agent, such as the commercially available block polysiloxane-polyoxyalkylene copolymers. The present invention uses inert gas frothed polyurethane compositions. The use of blown polyurethane compositions and unfoamed polyurethane compositions do not form a part of the present invention.

Inert gas frothed polyurethane compositions are formed by combining Side A and Side B, neither of which contain a blowing agent, and mechanically whipping an inert gas, such as air, into the polyurethane composition to thereby form a frothed, uncured polyurethane foam. Many different machines are known to be useful for forming frothed polyurethane foams, such as a conventional kitchen mixer. Commercial machines are also available for preparing frothed polyurethane compositions, such as Oakes froth machines available from E.T. Oakes Corp. of Hauppauge, N.Y. As a part of the present invention, it is desirable to form frothed polyurethane foams having a density of approximately 7 pounds per cubic foot to approximately 30 pounds per cubic foot; preferably approximately 10 pounds per cubic foot to approximately 25 pounds per cubic foot.

Due to the presence of a catalyst in the polyurethane composition, the frothed polyurethane composition will cure at room temperature. Curing can be further accelerated by using more catalyst or by heating the frothed polyurethane composition. In accordance with the present invention, it is desirable to have a frothed polyurethane composition that provides an apparent cure within approximately 3 to approximately 60 minutes; preferably within approximately 4 to approximately 30 minutes. As used herein the term “apparent cure” means that the foam possesses some resiliency.

Catalysts that are useful in the present invention include, but are not limited to, organic metal compounds, amines, and metal soaps, and include dibutyl tin dilaurate and stannous octanoate. The amount of catalyst that is included in the frothed polyurethane compositions useful in the present invention is that amount which provides the apparent cure times listed above. Those amounts are approximately 0.005 parts to 2.0 parts of catalyst per 100 parts of polyol; preferably approximately 0.01 parts to 1.5 parts of catalyst per 100 parts of polyol.

In order to form a frothed polyurethane foam, it is necessary to include a surfactant in the polyurethane composition. The particular surfactant used in the frothed polyurethane composition of the present invention is not critical and includes, but is not limited to, silicone glycol copolymers, such as L5614 available from Crompton Corp. The amount of surfactant that is used in the frothed polyurethane composition of the present invention is an amount sufficient to form a froth of the desired density and generally includes, but is not limited to, approximately 0.1 parts to 3.0 parts of surfactant per 100 parts of polyol; preferably approximately 0.25 parts to 2.0 parts of surfactant per 100 parts of polyol.

A general polyurethane formulation that is useful in the present invention is shown in Table I below:

TABLE I

| Ingredient | Parts |
|---|---|
| Polyol | 100 |
| Surfactant (silicon glycol | 1.0 |
| copolymer) | |
| Other filler | 0-400 |
| Additives | 0-50 |
| Catalysts | 1.0 |
| Isocyanate | sufficient |
| | (index 70-130) |

The tire in accordance with the present invention is filled with the frothed polyurethane composition as described below. The tire carcass 12 is mounted on the wheel rim 14 in a conventional manner. The hose 22 is connected to the valve stem 20 and air from the source 28 is introduced into the tire through the valve stem. The air fills the annular cavity 38 defined by the tire carcass 12 and the wheel 16. A sufficient amount of air is introduced into the tire 10 so that the tire bead 40 seats on the wheel rim 14 and forms an airtight seal, as is well known in the art. Additional air is introduced into the cavity 38 so that the tire 10 is inflated to a desired air pressure, such as 10 psi to 50 psi depending on the particular application for which the tire will be used.

After the tire 10 has been inflated to a desired air pressure, the valve 24 is switched so that frothed polyurethane composition from the source 36 is delivered into the cavity 38 of the tire 10. Since the uncured frothed polyurethane is discharged from the froth machine 36 under a pressure greater than 50 psi, there is no need to provide a pump to deliver the polyurethane froth to the tire cavity 38. Prior to switching the valve 24, or simultaneously therewith, a hollow needle 42 is inserted into the tread portion 44 of the tire carcass 12 so that the tip of the needle penetrates into the cavity 38. The needle 42 is connected to a clear plastic tube 44 which is connected to an adjustable pressure relief valve 46. The pressure relief valve can be adjusted to permit the venting of air therethrough at pressures above a selectable desired pressure. For example, if the pressure relief valve 46 is set at 15 psi, at pressures below 15 psi no air will be vented through the valve, but at pressures above 15 psi air will be vented through the valve so that the pressure in the tire 10 will not exceed 15 psi.

When the valve 24 is switched so that frothed polyurethane composition from the source 36 is delivered to the cavity 38 of the tire 10, the frothed polyurethane composition passes through the valve stem 20 and into the cavity 38. As the frothed polyurethane composition fills the cavity 38, it displaces an equal volume of air. The displacement of the air by the frothed polyurethane composition causes the air in the cavity 38 to be compressed, thereby raising the air pressure within the cavity. When the air pressure in the cavity 38 exceeds the level set on the adjustable pressure relief valve 46, the air in the cavity will vent through the needle 42, tube 44 and pressure relief valve 46, so that the air pressure in the cavity does not exceed the set level.

Frothed polyurethane composition continues to fill the cavity 38 until all of the air in the cavity is displaced thereby. This point can be determined by viewing through the clear tube 44. When frothed polyurethane is seen entering the tube 44, the valve 24 is closed so that neither air nor frothed polyurethane composition are introduced into the cavity 38. At this point, the tire 10 is completely filled with uncured polyurethane composition. The tube 22 can then be removed from the stem valve 20. The needle 42, tube 44 and pressure relief valve 46 can also be removed from the tire 12 since the rubber will pinch closed and thereby not allow the polyurethane foam within the cavity 38 to escape.

As stated above, the polyurethane composition may be designed so that it will cure at room temperature or it can be heated to accelerate the cure. However, it is preferred that the polyurethane composition cure at room temperature. Furthermore, as stated above, it is preferred that the polyurethane composition attains an apparent cure within 60 minutes.

As a part of the present invention, it has been discovered that tires made in accordance with the present invention have better wear properties than polyurethane filled tires in which the polyurethane composition was introduced to the tire as a liquid and chemically blown within the tire.

The vehicles for which the tires of the present invention are preferred are off-road vehicles, such as wheelbarrows, golf carts, lift trucks, lawn mowers, tractors, utility carts, other low speed vehicles, and the like.

The following examples are illustrative of the present invention and are not intended to limit the scope of the invention as set forth in the appended claims. All temperatures are in degrees Fahrenheit and all percentages are by weight unless specifically stated otherwise.

### EXAMPLE 1

Polyurethane compositions were prepared according to the formulas shown in Table II below:

TABLE VIII

| Ingredient | Formula A | Formula B | Formula C |
|---|---|---|---|
| Voranol 4701 | 90 | 90 | 90 |
| Diethylene glycol | 10 | 10 | 10 |
| Molecular sieve | 3 | 3 | 3 |
| Calcium Carbonate | 100 | 50 | 0 |
| L-5614 | 2.0 | 2.0 | 2.0 |
| Isocyanate 7940 | 39.43 | 39.43 | 39.43 |

In the foregoing formulas, Voranol 4701 is a polyether polyol with ethylene end caps available from Dow Chemical Company, Midland, Mich.; the molecular sieve is a ceramic zeolite resin that absorbs water available from Zeochem of Louisville, Ky. under the trade name Purmol powder; L-5614 is a silicone glycol copolymer surfactant available from Crompton Corp. of Danbury, Conn.; and 7710 is a polymeric MDI available from Dow Chemical Company.

Three separate mechanically frothed formulations were prepared according to the foregoing formulas. The three different formulations were used to prepare frothed polyurethane filled tires as described herein. Each of the tires showed improved wear properties.

### EXAMPLE 2

Tires prepared in accordance with the present invention were compared to commercially available tires filled with chemically blown polyurethane. The tires were tested using a modified Federal Motor Vehicle Standard #109 for passenger car tires. The tires were run on a dynamometer against a 66.2-inch diameter road wheel at a speed of 5 mph. The tires were run with a 400 lb Maximum Required Load (MRL) according to the schedule shown below:

4 hours at 85% MRL or 340 lbs

6 hours at 90% MRL or 360 lbs

24 hours at 100% MRL or 400 lbs

After a 5-minute run-in, two sets of temperature probe holes were drilled 180° apart in the flat proof tires, one just under the tread, the other in the center of the tire section. To monitor the ride rate and stiffness of the tires, load-deflection curves were run at zero hours and 7 hours. Tire footprints were also prepared at 400 lbs, as well as 500 lbs MRL. An otherwise identical pneumatic tire pressurized to 30 psi was also subject to the same testing.

The commercially available flat proof tires tested were an Everhard 10 and an Everhard 11 commercially available from Home Depot and a FF-3 Foam tire where the foam was manufactured by Arnco of Southgate, Calif. (foam) and the size 480/400-8 tire was manufactured by Cheng Shin, China. These three commercial tires were compared against two tires prepared according to the present invention.

The tires had different failure modes. The Arnco FF-3 foam tire test was discontinued when its temperature exceeded 300° after 4.1 hours. One of the two Everhard tires popped off its rim after 2 hours; the other one developed a circumferential split down the groove in the middle of the tread at 4.1 hours. Testing was discontinued on one of the tire according to the present invention (5936 cc) at 400 lbs when the temperature exceeded 300° at 18.8 hours, testing on the other tire (5905 cc) was stopped when granular foam particles began falling out of a one-half inch hole in the wheel rim at 16.8 hours.

The results of a first tire footprint area and life tests are shown in Table III below:

TABLE III

| Tire | 0 hours | 7 hours | 34 hours | Life |
|---|---|---|---|---|
| Arnco FF-3 @ 300 lbs | 9.0 in² | 10.9 in² | 11.9 in² | 44 hrs |
| Invention @ 300 lbs | 12.6 in² | 12.4 in² | 16.5 in² | 74 hrs |

The results of a second tire footprint area and life tests are shown in Table IV below:

TABLE IV

| Tire | 0 hours | 7 hours | Life | |
|---|---|---|---|---|
| Everhard 10 @ 400 lbs | 9.9 in² | | 4.08 | hrs |
| Everhard 10 @ 500 lbs | 11.6 in² | | | |
| Everhard 11 @ 400 lbs | 9.4 in² | | 2.08 | |
| Everhard 11 @ 500 lbs | 11.9 in² | | | |
| FF-3 Foam @ 400 lbs | 9.3 in² | | 4.08 | |
| FF-3 Foam @ 500 lbs | 11.2 in² | | | |
| Invention 5905 cc @ 400 lbs | 11.3 in² | 14.3 in² | 16.83 | hrs |
| Invention 5905 cc @ 500 lbs | 11.8 in² | 18.2 in² | | |
| Invention 5936 cc @ 400 lbs | 12.3 in² | 15.6 in² | 18.08 | hrs |
| Invention 5936 cc @ 500 lbs | 13.3 in² | 17.5 in² | | |

Load-deflection curves (the “ride” of the tire) were measured at the beginning of the test and at 7 hours. The tires in accordance with the present invention tested a little softer than the other tires, deflecting about ⅛ inch more at 300 lbs. FIG. 3 shows the load-deflection curve of the Everhard and Arnco tires clustered together in a group, all having similar slopes (ride rate). At 300 lbs, the tires in accordance with the present invention had a slope about equal to that of the other tires. But at 400 lbs, the tires of the present invention are slightly softer. Its deflection is about ⅛ inch greater than the others at 300 lbs, and about 3/16 inch more at 400 lbs.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A tire for a vehicle, said tire at least partially defining a hollow cavity, said hollow cavity being at least partially filled with cured frothed polyurethane foam.

2. The tire of claim 1, wherein said cavity is substantially filled with said frothed polyurethane foam.

3. The tire of claim 1, wherein said cavity is filled with said frothed polyurethane foam.

4. The composition of claim 1, wherein said frothed polyurethane foam has a density after curing of approximately 10 lbs to 30 lbs per cubic foot.

5. A tire for a vehicle comprising:
a tire carcass;
a wheel rim on which said tire is mounted, said tire carcass and wheel rim defining a hollow cavity; and
said hollow cavity being at least partially filled with uncured frothed polyurethane foam at a desired pressure.

6. A method comprising the steps of:
inflating with air to a desired pressure a tire casing mounted on a wheel rim;
displacing said air in said tire casing with uncured frothed polyurethane foam by injecting said uncured frothed polyurethane foam into said tire casing; and
curing said frothed polyurethane foam in said tire casing.

7. The method of claim 6, wherein said frothed polyurethane foam is injected into said tire casing under pressure while venting said air from said casing and while maintaining said desired pressure in said tire casing.

8. The method of claim 6, wherein said desired pressure is approximately 10 psi and 50 psi.

9. The composition of claim 6, wherein said frothed polyurethane foam has a density after curing of approximately 10 lbs to 30 lbs per cubic foot.

10. A method comprising the steps of:
forming a mixture of at least one polyol, an isocyanate, a catalyst or catalyst system for forming polyurethane, and a surfactant;
forming said mixture into a frothed foam,
displacing air under pressure in a tire casing with said frothed foam by injecting said uncured frothed foam into said tire casing; and
curing said frothed foam to form a polyurethane foam composition.

11. The method of claim 10, wherein said frothed foam is injected into said tire casing under pressure while venting said air from said casing and while maintaining a desired pressure in said tire casing.

12. The method of claim 11, wherein said desired pressure is approximately 10 psi to approximately 50 psi.

13. The method of claim 10, wherein said frothed polyurethane foam has a density after curing of approximately 10 lbs per cubic foot to 30 lbs per cubic foot.

14. A method comprising the steps of:
forming a mixture of at least one polyol, an isocyanate, a catalyst or catalyst system for forming polyurethane, and a surfactant into a frothed foam,
displacing air under pressure in a tire casing with said frothed foam by injecting said frothed foam into said tire casing; and
curing said frothed foam to form a polyurethane foam composition.

15. The method of claim 14, wherein said frothed foam is injected into said tire casing under pressure while venting said air from said casing and while maintaining a desired pressure in said tire casing.

16. The method of claim 15, wherein said desired pressure is approximately 10 psi to approximately 50 psi.

17. The method of claim 14, wherein said frothed polyurethane foam has a density after curing of approximately 10 lbs per cubic foot to 30 lbs per cubic foot.

18. A tire made by the method of claim 10.

19. A tire made by the method of claim 14.

20. A flat-free tire comprising a tire casing and cured frothed polyurethane foam confined, at least in part, by said tire casing.

21. A tire and wheel rim assembly comprising:
a tire having a reinforced carcass;
a wheel rim on which the tire is mounted to define a chamber; and
said chamber having a filling of cured frothed polyurethane foam.

22. A method comprising the steps of:
inflating with air to a desired pressure a tire casing mounted on a wheel rim;
displacing said air in said tire casing with uncured frothed polyurethane foam by introducing said uncured frothed polyurethane foam into said tire casing, while maintaining said desired pressure in said tire casing; and
curing said frothed polyurethane foam in said tire casing.
